(19) United States
(12) Patent Application Publication
(10) Pub. No.: US 2023/0196934 A1
(43) Pub. Date: Jun. 22, 2023

(54) APPARATUS AND METHOD FOR SUPPORTING LANGUAGE LEARNING USING VIDEO

(71) Applicant: WOONGJIN THINKBIG CO., LTD., Paju-si (KR)

(72) Inventors: Samrak CHOI, Paju-si (KR); Uiyoung KIM, Paju-si (KR); Yooli HAN, Paju-si (KR); Sangboon KIM, Paju-si (KR)

(73) Assignee: WOONGJIN THINKBIG CO., LTD., Paju-si (KR)

(21) Appl. No.: 18/085,358

(22) Filed: Dec. 20, 2022

(30) Foreign Application Priority Data
Dec. 21, 2021 (KR) 10-2021-0183345

(51) Int. Cl. G09B 5/06; G10L 25/57; G10L 17/04; G10L 17/22; G10L 17/02; G10L 21/028; G06F 40/295; G06F 3/0482; G06F 3/0484

(52) U.S. Cl. CPC G09B 5/065; G10L 25/57; G10L 17/04; G10L 17/22; G10L 17/02; G10L 21/028; G06F 40/295; G06F 3/0482; G06F 3/0484

(57) ABSTRACT

Proposed are an apparatus and a method for supporting language learning, which can classify voices of a language learning video for each character, convert the voices for each character into texts, and provide utterance levels of characters. The proposed apparatus for supporting language learning generates voices for each person classified for each character through collection of voices in a language learning video, which are uttered on the language learning video being viewed by a learner, configures utterance levels (i.e., person levels) of the characters through conversion of the voices for each person into texts for each person, and displays a learning support screen including the texts for each person and the utterance levels.

### TECHNICAL FIELD

The present disclosure relates to an apparatus and a method for supporting language learning of a learner using a video.

### BACKGROUND ART

In general, a learner learns a language in a manner of learning through a textbook composed of a language intended to be learned or viewing a video composed of a language intended to be learned.

Although there are various language learning methods, it is effective in language learning to actually experience the language rather than to understand the language through books and prints or to indirectly experience an environment in which the language is actually used through a video because to do so can help faster learning of the language.

Recently, with the development of communication technology, various services for supporting language learning of learners have been provided through a communication network such as Internet.

However, a language learning service is to provide predetermined language learning content through a communication network, and thus it is merely to the extent of changing an offline method for learning a textbook or a video to an online method thereof. That is, the language learning service is merely to the extent of transforming an actual book or language learning data composed of a video into data that can be viewed on a communication device to provide the transformed data.

The matters described in the above background technology are to help understanding of the background of the present disclosure, and may include the matters that are not the disclosed technology in the related art.

### PRIOR ART DOCUMENT

(Patent document) Korean Registered Patent No. 10-1427528

### DISCLOSURE

### Technical Problem

The present disclosure has been proposed in consideration of the above-described circumstances, and an object of the present disclosure is to provide an apparatus and a method for supporting language learning, which enable a learner to learn a language of a suitable level by classifying voices of a language learning video for each character, converting the voices for each character into texts, and providing utterance levels of characters. That is, an object of the present disclosure is to provide a language learning screen suitable for difficulty to a learner by classifying and generating voices of a language learning video for each character, converting the voices for each character into texts, and analyzing the texts for each character.

### Technical Solution

According to an embodiment of the present disclosure for achieving the above object, an apparatus for supporting language learning includes: a voice collection module configured to: collect voices that are uttered in a language learning video being viewed by a learner, and output a speaker classification request message including the voices in the video in response to a video end message that is generated when a playback of the language learning video is ended; a speaker classification module configured to: generate voices for each person through classification of the voices in the video for each character collected by the voice collection module in response to the speaker classification request message of the voice collection module, output a text conversion request message including the voices for each person, detect texts for each person detected from a text conversion complete message that is a response to the text conversion request message, generate voice information for each character including the voices for each person and the texts for each person, and output a storage request message including the voice information for each character; a text conversion module configured to: generate the texts for each person through conversion of the voices for each person detected from the text conversion request into the texts in response to the text conversion request of the speaker classification module, and output the text conversion complete message including the texts for each person; a storage module configured to: store the voice information for each character in response to a storage request message of the speaker classification module, output a response including person identifiers and the texts for each person in response to a text detection request message for each person, detect the person identifiers and the texts for each person in response to a person level storage request message, output a response including the person identifiers and utterance levels, and store person levels in association with the voice information for each character in response to the person level storage request message; a person level configuration module configured to: transmit the text detection request message for each person to the storage module in response to a storage complete message of the storage module, configure the utterance levels of characters by analyzing the person identifiers and the texts for each person detected from the response of the storage module with respect to the text detection request message for each person, and transmit the person level storage request message including the person identifiers and the utterance levels to the storage module; and a learning support module configured to output one or more learning support screens based on the voice information for each character stored in the storage module in response to a language learning start request.

The speaker classification module may be configured to: detect the voices in the video from the speaker classification request message of the voice collection module, and determine whether a character newly appears based on voiceprints of the voice information for each pre-generated character and the voices in the video, and the speaker classification module may be configured to: determine the appearing character as the existing character if the voice information for each character having the same voiceprint as the voiceprint of the voice in the video exists, and determine the appearing character as a new character if the voice information for each character having the same voiceprint as the voiceprint of the voice in the video does not exist.

The speaker classification module may be configured to: generate a person identifier if the appearing character is determined as the new character, generate a voiceprint based on the voice determined as the new character, generate the voice information for each character including the person identifier and the voiceprint, detect, from the voices in the video, an utterance start time and an utterance end time of the voice having the same voiceprint as the voiceprint of the voice information for each character, and detect, from the voices in the video, the voice between the utterance start time and the utterance end time as the voice for each person.

The speaker classification module may be configured to divide the voice information for each person for each scene based on the utterance start time and the utterance end time, if a difference between an utterance end time of voice information for each first person of a first character and an utterance start time of voice information for each second person is equal to or shorter than a predetermined time, the speaker classification module may be configured to configure the voice information for each of the two persons as one scene, and if an utterance start time of voice information for each person of a second character exists between the voice information for each person of the first character, the speaker classification module may be configured to configure the voice information for each person of the second character as the same scene as the scene of the voice information for each person of the first character.

The person level configuration module may be configured to: output a text detection request for each person, detect the person identifier and the texts for each person from a response of the storage module with respect to the text detection request for each person, classify the texts for each person for each character based on the person identifiers detected in the step of detecting the person identifiers and the texts for each person, configure the utterance levels of the characters by analyzing the texts for each person classified for each character, and output, to the storage module, a person level storage request message including the person identifiers and the utterance levels.

The learning support module may be configured to: output a character detection request message, detect the person identifiers and the person levels from character information if the character information is received in response to the character detection request message, output a character selection screen for displaying the characters of the language learning video so as to display the person levels of the characters and the character selection screen including character selection buttons matching the person identifiers, detect the person identifiers in association with the character selection buttons selected by the learner, output a scene detection request message including the person identifiers, match the scene identifiers detected from character scene information that is a response to the scene detection request message with the scene selection buttons if the character scene information is received, output a scene selection screen including the scene selection buttons, and output a scene dialog screen on which the texts for each person are arranged in association with the scene identifiers in association with the scene selection buttons selected by the learner.

The learning support module may be configured to: generate a scene dialog voice on which the voices for each person are arranged so that the voices are located in front as the utterance start time thereof is earlier, and output the scene dialog voice together with the scene dialog screen.

The learning support module may be configured to: output a voice information detection request message for each person including the scene identifiers in association with the scene selection buttons selected by the learner, detect the voices for each person, the texts for each person, the utterance start time and the utterance end time from scene information as a response to the voice information detection request message for each person if the scene information is received, configure a scene dialog time including a scene dialog start time configured as the detected earliest utterance start time and a scene dialog end time configured as the detected latest utterance end time, and output the scene dialog screen including scene dialog texts on which the texts for each person are arranged based on the utterance start time.

The language learning video may be output together with the scene dialog screen from a time line corresponding to the scene dialog start time of the scene dialog time to a time line corresponding to the scene dialog end time.

According to an embodiment of the present disclosure for achieving the above object, a method for supporting language learning performed by a language learning support apparatus includes: collecting voices that are uttered in a language learning video being viewed by a learner; generating voice information for each character including voices for each person through classification of the voices in the video for each character collected in the step of collecting the voices in the video and texts for each person through conversion of the voices for each person into the texts; storing the voice information for each character generated in the step of generating the voice information for each character; configuring utterance levels of characters by analyzing the voice information for each character stored in the step of storing the voice information for each character, and configuring the utterance levels as person levels of the characters; and outputting a learning support screen including the person levels configured in the step of configuring as the person levels and the voice information for each character.

The generating of the voice information for each character may include: detecting, by a speaker classification module, the voices in the video from a speaker classification request message of a voice collection module having collected the voices in the video; determining, by the speaker classification module, whether a character newly appears based on the voice information for each pre-generated character and the voices in the video; generating, by the speaker classification module, the voice information for each character including person identifiers and voiceprints if the character is determined as a new character in the step of determining the characters; detecting, by the speaker classification module, an utterance start time and an utterance end time of the voice having the same voiceprint from the voices in the video detected in the detection step; detecting, by the speaker classification module, the voice between the utterance start time and the utterance end time among the voices in the video as the voice for each person; outputting, by the speaker classification module, a voice-text conversion request message including the voices for each person, and detecting texts for each person through conversion of the voices for each person into the texts from a text conversion complete message that is a response to the voice-text conversion request message; generating, by the speaker classification module, voice information for each person including the voices for each person, the texts for each person, the utterance start time, and the utterance end time; and associating, by the speaker classification module, the voice information for each person generated in the step of generating the voice information for each person with the voice information for each character generated in the step of generating the voice information for each character.

The generating of the voice information for each character may include: detecting, by a speaker classification module, the voices in the video from a speaker classification request message of a voice collection module having collected the voices in the video; determining, by the speaker classification module, whether a character newly appears based on the voice information for each pre-generated character and the voices in the video; detecting, by the speaker classification module, the voice information for each character having the same voiceprints as voiceprints of the voices in the video if the character is determined as an existing character in the step of determining the characters; detecting, by the speaker classification module, an utterance start time and an utterance end time of the voice having the same voiceprint as the voiceprint of the voice information for each character from the voices in the video; detecting, by the speaker classification module, the voice between the utterance start time and the utterance end time among the voices in the video as the voice for each person; outputting, by the speaker classification module, a voice-text conversion request message including the voices for each person, and detecting texts for each person through conversion of the voices for each person into the texts from a text conversion complete message that is a response to the voice-text conversion request message; generating, by the speaker classification module, voice information for each person including the voices for each person, the texts for each person, the utterance start time, and the utterance end time; and associating, by the speaker classification module, the voice information for each person generated in the step of generating the voice information for each person with the voice information for each character generated in the step of generating the voice information for each character.

The determining of whether the character newly appears may determine the character as the existing character if the voice information for each character having the same voiceprint as the voiceprint of the voice in the video exists, and determine the character as a new character if the voice information for each character having the same voiceprint as the voiceprint of the voice in the video does not exist.

The method may further include dividing, by the speaker classification module, the voice information for each person detected in the step of detecting as the voices for each person based on the utterance start time and the utterance end time for each scene, and the dividing for each scene may include: if a difference between the utterance end time of the voice information for each first person of a first character and the utterance start time of the voice information for each second person is equal to or shorter than a predetermined time, configuring the voice information for each of the two persons as one scene; and if the utterance start time of the voice information for each person of a second character exists between the voice information for each person of the first character, configuring the voice information for each person of the second character as the same scene as the scene of the voice information for each person of the first character.

The configuring of the utterance levels as person levels of the characters may include: outputting, by a person level configuration module, a text detection request for each person; detecting, by the person level configuration module, the person identifiers and the texts for each person from a response to the text detection request for each person; classifying, by the person level configuration module, the texts for each person for each character based on the person identifiers detected in the step of detecting the person identifiers and the texts for each person; configuring, by the person level configuration module, the utterance levels of the characters by analyzing the texts for each person classified for each character in the step of classifying for each character; and outputting, by the person level configuration module, a person level storage request message including the person identifiers and the utterance levels.

The outputting of the learning support screen may include: outputting, by a learning support module, a character detection request message; detecting, by the learning support module, the person identifiers and person levels from character information if the character information is received in response to the character detection request message; outputting, by the learning support module, a character selection screen for displaying the characters of the language learning video so as to display the person levels of the characters and the character selection screen including character selection buttons matching the person identifiers; detecting, by the learning support module, the person identifiers in association with the character selection buttons selected by the learner, and outputting a scene detection request message including the person identifiers; detecting, by the learning support module, scene identifiers from character scene information that is a response to the scene detection request message if the character scene information is received; matching, by the learning support module, the scene identifiers detected in the step of detecting the scene identifiers with scene selection buttons, and outputting a scene selection screen including the scene selection buttons; and outputting, by the learning support module, a scene dialog screen on which the texts for each person are arranged in association with the scene identifiers in association with the scene selection buttons selected by the learner.

The outputting of the scene dialog screen may include: outputting, by the learning support module, a voice information detection request message for each person including the scene identifiers in association with the scene selection buttons selected by the learner, and detecting the voices for each person, the texts for each person, the utterance start time and the utterance end time from scene information as a response to the voice information detection request message for each person if the scene information is received; configuring, by the learning support module, a scene dialog time including a scene dialog start time configured as the detected earliest utterance start time and a scene dialog end time configured as the detected latest utterance end time; generating, by the learning support module, the scene dialog texts on which the texts for each person are arranged based on the utterance start time; and outputting, by the learning support module, the scene dialog screen including the scene dialog texts.

The outputting of the scene dialog screen may further include: generating, by the learning support module, a scene dialog voice on which the voices for each person are arranged so that the voices are located in front as the utterance start time thereof is earlier; and outputting, by the learning support module, the scene dialog voice together with the step of outputting the scene dialog screen.

The outputting of the scene dialog screen may further include: outputting, by the learning support module, the language learning video from a time line corresponding to the scene dialog start time of the scene dialog time to a time line corresponding to the scene dialog end time together with the step of outputting the scene dialog screen.

### Advantageous Effects

The apparatus and the method for supporting language learning according to the present disclosure have effects in that a learner is able to learn a language of a suitable level by classifying voices of a language learning video for each character, converting the voices for each character into texts, and providing utterance levels of characters.

Further, the apparatus and the method for supporting language learning according to the present disclosure have effects in that combinations of media and writing types can be naturally and friendly provided to children having difficulty in language learning and children preparing for admission to school, and thus it is possible to arouse their interest in learning and to stimulate their curiosity.

Further, although the apparatus and the method for supporting language learning according to the present disclosure have been proposed in a state where English is taken for example, the present disclosure can help solve illiteracy through application thereof to countries or regions in which many illiterate persons live in case of national languages.

### DESCRIPTION OF DRAWINGS

FIG. 1 is a diagram explaining an apparatus for supporting language learning using a video according to an embodiment of the present disclosure.

FIG. 2 is a diagram explaining the configuration of an apparatus for supporting language learning using a video according to an embodiment of the present disclosure.

FIG. 3 is a diagram explaining a storage module of FIG. 2.

FIGS. 4 to 8 are diagrams explaining a learning support module of FIG. 2.

FIG. 9 is a diagram explaining a modified example of an apparatus for supporting language learning using a video according to an embodiment of the present disclosure.

FIG. 10 is a flowchart explaining a method for supporting language learning using a video according to an embodiment of the present disclosure.

FIGS. 11 and 12 are flowcharts explaining a step of generating voice information for each character of FIG. 10.

FIG. 13 is a flowchart explaining a step of configuring a person level of FIG. 10.

FIGS. 14 and 15 are flowcharts explaining s step of outputting a language learning support screen of FIG. 10.

### MODE FOR INVENTION

Hereinafter, preferred embodiments of the present disclosure will be described in detail with reference to the accompanying drawings.

Embodiments are provided to describe the present disclosure more completely to those of ordinary skill in the art, and the following embodiments may be modified in various different forms, and thus the scope of the present disclosure is not limited to the following embodiments. Rather, these embodiments are provided to make the present disclosure more faithful and complete and to completely transfer the idea of the present disclosure.

The terms used in the description are used to describe specific embodiments, and are not intended to limit the present disclosure. Further, in the description, unless clearly indicated otherwise in context, a singular form may include a plural form.

In describing the embodiments, in case that each layer (film), area, pattern, or structure is described to be formed “on” or “under” each substrate, layer (film), area, pad, or pattern, the terms “on” and “under” include both “direct” or “indirect” forming. Further, the criterion of “on” or “under” each layer is principally based on the drawings.

The drawings are merely to understand the idea of the present disclosure, and it should not be interpreted that the scope of the present disclosure is not limited by the drawings. Further, in the drawings, a relative thickness, length, or size may be exaggerated for convenience and accuracy of the description.

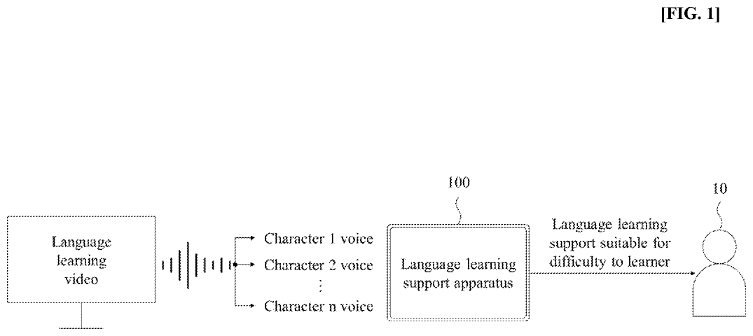

Referring to FIG. 1, an apparatus 100 for supporting language learning according to an embodiment of the present disclosure divides and collects voices, which are reproduced by a TV, smart phone, or tablet or uttered in a self-reproduced language learning video, for each character, and supports language learning of various forms (e.g., dictation, shadowing reading, and fill in the blanks) to a learner by using the voices classified for each character.

The language learning support apparatus 100 supports language learning that is suitable for difficulty to a learner by performing text analysis of data after performing automatic voice analysis for each character, such as protagonist and supporting actor, in a language drama or a language video that is familiar to a learner.

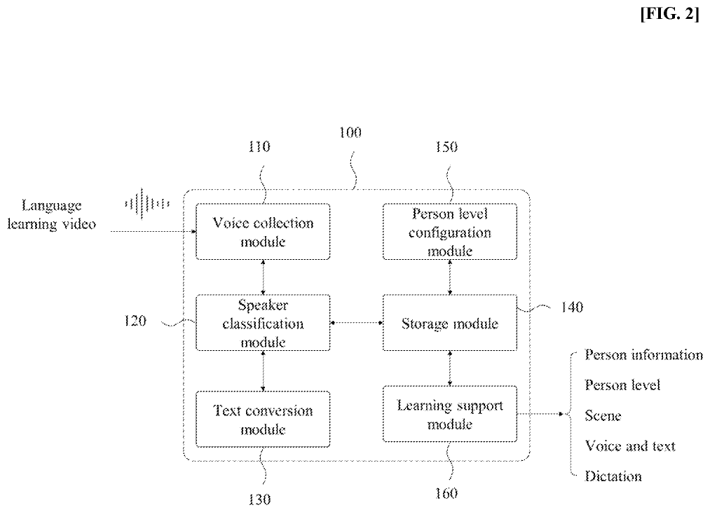

Referring to FIG. 2, the language learning support apparatus 100 is configured to include a voice collection module 110, a speaker classification module 120, a text conversion module 130, a storage module 140, a person level configuration module 150, and a learning support module 160.

The voice collection module 110 collects voices (i.e., voices in a video) that are uttered in a language learning video being viewed by a learner. In this case, the language learning video may be a video that is played by a video player, such as a TV, a smart phone, or a tablet, or a video that is played by the language learning support apparatus 100 according to an embodiment of the present disclosure. It is exemplified that the language learning video is a video of a drama, movie, or animation composed of language voices that are the target of learning.

The voice collection module 110 collects voices being uttered from the language learning video in response to a video start message. In this case, the voice collection module 110 may recognize first occurrence sound (voice) after the language learning video is played as the video start message. The voice collection module 110 may receive the video start message from a video player that plays the language learning video. In case that the video is played by the language learning support apparatus 100, the voice collection module 110 may recognize a playback request input by a learner as the video start message.

The voice collection module 110 generates a speaker classification request message in response to a video end message, and transmits the speaker classification request message to the speaker classification module 120. In this case, the voice collection module 110 generates the speaker classification request message including the collected voices in the video.

The speaker classification module 120 generates voice information for each character by classifying the voices in the video for each character in response to the speaker classification request message of the voice collection module 110. That is, since several characters including the protagonist appear in the language learning video, the speaker classification module 120 generates voice information for each character by classifying the voices in the video of the language learning video for each character.

The speaker classification module 120 detects the voices in the video from the speaker classification request message. The speaker classification module 120 determines the character by comparing the voice information for each character including the person identifier and the voiceprint with the voices in the video detected from the speaker classification request message.

In this case, if there is the voice information for each character having the same voiceprint as the voiceprint of the voice in the video, the speaker classification module 120 determines it as the existing character. If there is not the voice information for each character having the same voiceprint as the voiceprint of the voice in the video, the speaker classification module 120 determines it as a new character.

If it is determined as the new character, the speaker classification module 120 configures the person identifier. The speaker classification module 120 generates the voiceprint by quantifying the voice characteristics of the corresponding person. The speaker classification module 120 generates the voice information for each character including the person identifier and the voiceprint. In this case, the speaker classification module 120 detects the person name that is the name of the character from the voices of the characters, and may also generate the voice information for each character further including the person name.

In this case, the speaker classification module 120 detects an utterance start time and an utterance end time of the voice having the same voice characteristics as the characteristics of the voiceprint of the voice information for each character. Here, the utterance start time means the time when the voice utterance of the corresponding person starts in the language learning video, and the utterance end time means the time when the voice utterance of the corresponding person is ended.

The speaker classification module 120 detects, from the voices in the video, the voice between the utterance start time and the utterance end time as the voice for each person. The speaker classification module 120 generates a voice-text conversion request message including the detected voice for each person, and transmits the message to the text conversion module 130. The speaker classification module 120 receives a text conversion complete message in response to the voice-text conversion request message.

The speaker classification module 120 detects texts for each person from the text conversion complete message. The speaker classification module 120 associates the voice information for each person with the voice information for each character including the person identifiers, the person names, and the voiceprints. In this case, the voice information for each person includes the voice for each person, the text for each person, the utterance start time, and the utterance end time.

Meanwhile, if it is determined as the existing character, the speaker classification module 120 detects the voice information for each character having the same voiceprint as the voiceprint of the voice.

The speaker classification module 120 detects the utterance start time and the utterance end time of the voice having the same voice characteristics as the voice characteristics of the voiceprint of the voice information for each character. The speaker classification module 120 detects the voice between the utterance start time and the utterance end time among the voices in the video as the voice for each person.

The speaker classification module 120 generates the voice-text conversion request message including the detected voice for each person, and transmits the message to the text conversion module 130. The speaker classification module 120 receives the text conversion complete message in response to the voice-text conversion request message.

The speaker classification module 120 detects texts for each person from the text conversion complete message. The speaker classification module 120 additionally associates the voice information for each person with the detected voice information for each character. In this case, the voice information for each person includes the voice for each person, the text for each person, the utterance start time, and the utterance end time.

If the speaker classification with respect to the voices in the video is completed, the speaker classification module 120 generates a voice information storage request message for each character including the voice information for each character. That is, the speaker classification module 120 generates the voice information storage request message for each character including the person identifiers, the person names, the voiceprints, and the voice information for each person. The speaker classification module 120 transmits the voice information storage request message for each character to the storage module 140.

Meanwhile, the speaker classification module 120 may divide the voice information for each person for each scene. That is, after a predetermined period (time) is set after a dialog between characters takes place in one scene, a dialog takes place in a next scene. Based on this, the speaker classification module 120 divides the voice information for each person for each scene.

If a difference between an utterance end time of voice information for each first person of a first character and an utterance start time of voice information for each second person is equal to or shorter than a predetermined time, the speaker classification module 120 configures the voice information for each of the two persons as one scene. In this case, if an utterance start time of voice information for each person of a second character exists between the voice information for each person of the first character, the speaker classification module 120 classifies the voice information for each person of the second character as the same scene as the scene of the voice information for each person of the first character.

If the difference between the utterance end time of the voice information for each first person and the utterance start time of the voice information for each second person exceeds the predetermined time, the speaker classification module 120 configures the voice information for the first person and the voice for the second person as different scenes.

If the scene classification is completed, the speaker classification module 120 generates the voice information storage request message for each character including the voice information for each character. That is, the speaker classification module 120 generates the voice information storage request message for each character including the person identifiers, the person names, the voiceprints, and the voice information for each person, and transmits the message to the storage module 140. In this case, the voice information for each person includes the voice for each person, the text for each person, the utterance start time, the utterance end time, and the scene.

The text conversion module 130 converts the voices for each person into texts in response to the voice-text conversion request message of the speaker classification module 120. The text conversion module 130 detects the voices for each person from the voice-text conversion request message. The text conversion module 130 generates the texts for each person by converting the voices for each person into text values through voice recognition (speech to text (STT)) of the voices for each person. The text conversion module 130 generates the text conversion complete message including the texts for each person, and transmits the text conversion complete message to the speaker classification module 120.

The storage module 140 stores the voice information for each character in response to a voice information storage request message for each character of the speaker classification module 120. The storage module 140 detects the voice information for each character from the voice information storage request message for each character. The storage module 140 detects the person identifiers, person names, voiceprints, and voice information for each person. The storage module 140 detects the voices for each person, texts for each person, utterance start time, and utterance end time from the voice information for each person. The storage module 140 associates and stores the person identifiers, person names, voiceprints, voices for each person, texts for each person, utterance start time, and utterance end time. The storage module 140 may further associate and store scenes included in the voice information for each person. After completion of the storage of the voice information for each character, the storage module 140 generates and transmits a storage complete message to the person level configuration module 150.

The storage module 140 detects the person identifiers and the texts for each person in response to the text detection request message for each person of the person level configuration module 150. The storage module 140 generates a response including the person identifiers and the texts for each person, and transmits the response to the person level configuration module 150.

The storage module 140 associates and stores person levels with the voice information for each character in response to a person level storage request message of the person level configuration module 150. The storage module 140 detects the person identifiers and utterance levels from the person level storage request message. The storage module 140 stores the utterance levels with the person levels of the voice information for each character in association with the detected person levels.

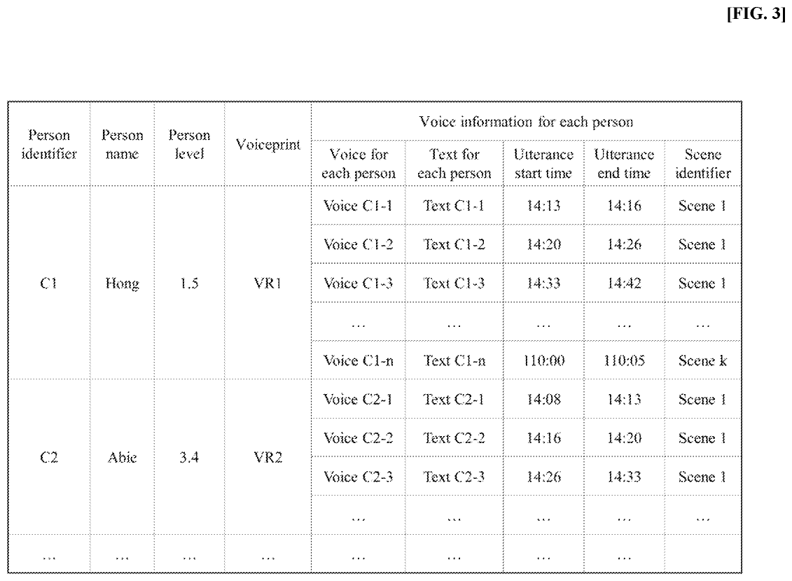

Accordingly, referring to FIG. 3, the storage module 140 stores therein the voice information for each character including the person identifiers, person levels, voiceprints, and one or more pieces of voice information for each person (voices for each person, texts for each person, utterance start time, utterance end time, and scenes (i.e., scene identifiers)).

The storage module 140 detects the person identifiers, person names, and person levels of all characters appearing in a language learning video as a response to a character detection request message of the learning support module 160. The storage module 140 transmits the character information including the person identifiers, person names, and person levels as the response to the character detection request message.

The storage module 140 detects scenes on which the character selected by the learner appears in response to a scene detection request message of the learning support module 160. The storage module 140 detects scene identifiers in association with the person identifiers detected from the scene detection request message. The storage module 140 transmits character scene information including the detected scene identifiers as the response to the scene detection request message.

The storage module 140 detects the voice information for each person and the person names of the scene selected by the learner in response to the voice information detection request message for each person of the learning support module 160. The storage module 140 detects the voice information for each person and the person names in association with the scent identifiers detected from the scene detection request message. The storage module 140 transmits the scene information including the detected person names and the voice information for each person as the response to the scene detection request message.

The person level configuration module 150 configures the person level of the character by using the level of vocabulary being used by the character appearing on the language learning video as a response to the storage complete message. The person level configuration module 150 generates and transmits a text detection request message for each person to the storage module 140.

The person level configuration module 150 detects the person identifiers and the texts for each person from the response to the text detection request message for each person. The person level configuration module 150 classifies the texts for each person for each character based on the person identifiers.

The person level configuration module 150 determines the level (hereinafter, word level) of a word used by the character in the video and the level (hereinafter, sentence level) of a sentence used by the character in the video through morphological analysis of the texts for each person classified for each character. The person level configuration module 150 configures the utterance level of the character by using the word level and the sentence level of the character. The person level configuration module 150 generates and transmits a person level storage request message including the person identifier and the utterance level to the storage module 140.

The learning support module 160 outputs a character selection screen D1 in response to the language learning start request of the learner having completed the viewing of the language learning video. In this case, the learning support module 160 outputs the character selection screen D1 on which the person level corresponding to the vocabulary level being used by the character is displayed.

The learning support module 160 generates and transmits a character detection request message to the storage module 140. The learning support module 160 detects the person identifiers, person names, and person levels from the character information that is a response by the storage module 140 to the character detection request message.

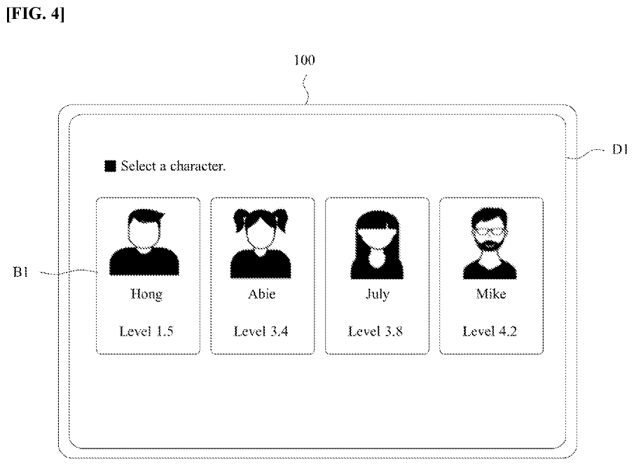

The learning support module 160 outputs a scene for displaying the characters of the language learning video. In this case, referring to FIG. 4, the learning support module 160 displays character selection buttons B1 on which icons, person names, and person levels of characters are displayed, and outputs a character selection screen D1 on which person identifiers match the character selection buttons B1.

The learner views the person levels on the character selection screen D1, and selects the character selection button B1 to fit the learner's level. In response to the character selection of the learner, the learning support module 160 outputs a scene selection screen D2 on which the character selected by the learner appears.

The learning support module 160 detects the person identifier in association with the character selection button B1 selected by the learner. The learning support module 160 generates and transmits a scene detection request message including the person identifier to the storage module 140.

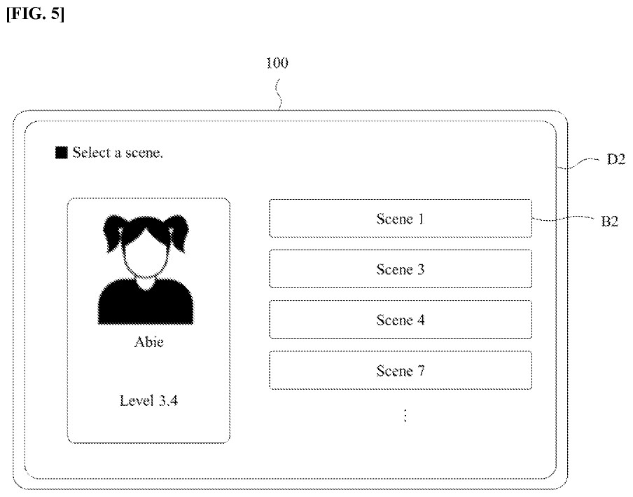

Referring to FIG. 5, the learning support module 160 detects scene identifiers from character scene information that is a response by the storage module 140 to the scene detection request message. The learning support module 160 outputs the scene selection screen D2 on which the character information including icons, person names, and person levels of characters are displayed and one or more scene selection buttons B2 are displayed. In this case, the learning support module 160 outputs the scene selection screen D2 on which the scene identifiers match the scene selection buttons B2.

If the scene selection button B2 displayed on the scene selection screen D2 is selected by the learner, the learning support module 160 outputs a text learning screen on which texts for each person of the scene selected by the learner are displayed.

The learning support module 160 generates a voice information detection request message for each person including the scene identifier in association with the scene selection button B2 selected by the learner, and transmits the voice information detection request message to the storage module 140.

The learning support module 160 detects person names and voice information for each person from the scene information that is a response by the storage module 140 to the voice information detection request message for each person. The learning support module 160 detects the voices for each person, texts for each person, utterance start time, and utterance end time from the detected voice information for each person.

The learning support module 160 configures the earliest time among the detected utterance start times as a scene dialog start time, and configures the latest time among the utterance end times as a scene dialog end time. The learning support module 160 generates a scene dialog time including a scene dialog start time and a scene dialog end time.

The learning support module 160 generates scene dialog texts by arranging the person names and the texts for each person based on the detected utterance start time. In this case, the learning support module 160 generates the scene dialog texts for arranging the person names and the texts for each person so that they are located in front (at the top) as the utterance start time thereof is earlier. In other words, the learning support module 160 arranges the person names and the texts for each person based on the detected utterance start time. In this case, the learning support module 160 generates the scene dialog texts on which the person names and the texts for each person are arranged so that they are located in front (at the top) as the utterance start time thereof is earlier.

The learning support module 160 generates scene dialog voices by arranging the voices for each person based on the detected utterance start time. In this case, the learning support module 160 generates the scene dialog voices on which the voices for each person are arranged so that they are located in front (at the top) as the utterance start time thereof is earlier.

The learning support module 160 displays the character information including the icons, person names, and person levels of the characters, and outputs the scene selection screen D2 on which one or more scene selection buttons B2 are displayed. In this case, the learning support module 160 outputs the scene selection screen D2 on which the scene identifiers match the scene selection buttons B2.

After the generation of the scene dialog texts is completed, or the generation of the scene dialog voices is completed, the learning support module 160 outputs a scene dialog screen D3 including the character information including the icons, person names, and person levels of the characters, a scene dialog time, and scene dialog texts. In this case, the learning support module 160 may output the scene dialog screen D3 further including a learning start button and/or an output button.

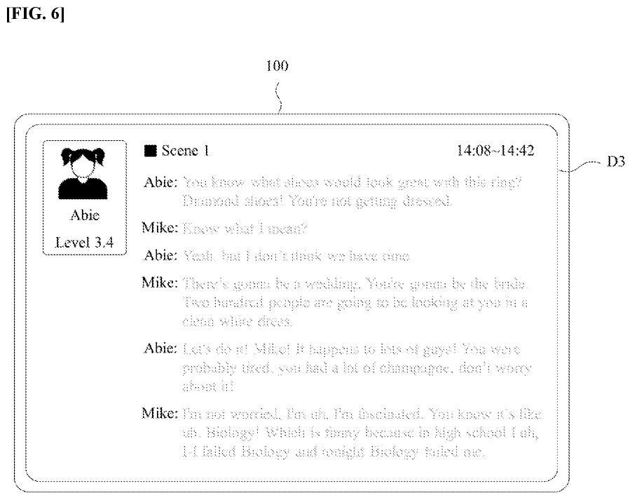

Referring to FIG. 6, in order for the learner to be able to proceed with dictation learning by outputting the scene dialog screen D3, the learning support module 160 may output the scene dialog screen D3 on which all texts included in the scene dialog texts are exposed to be displayed in light gray.

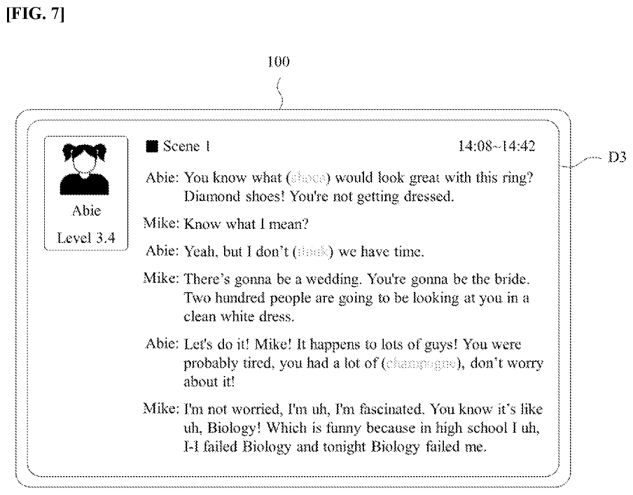

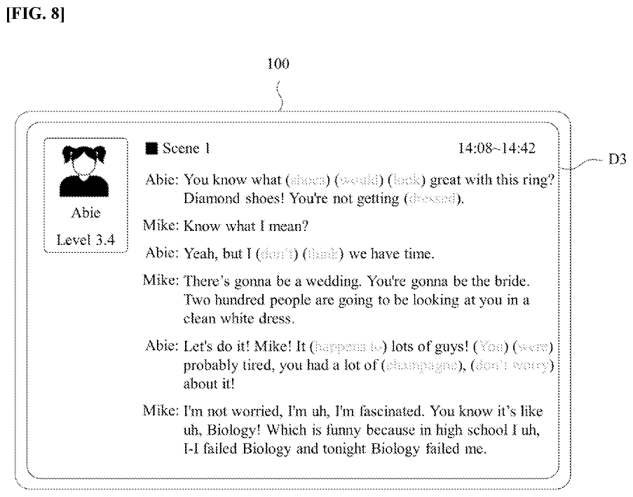

Referring to FIGS. 7 and 8, the learning support module 160 may parenthesize a specific text, and may output the scene dialog screen D3 displayed in light gray. In this case, the learning support module 160 may select the text being parenthesized based on the learner's vocabulary level or learning history. The learning support module 160 may output the scene dialog screen D3 displayed in light gray after parenthesizing the text corresponding to the parts of speech selected by the learner among nouns, adjectives, verbs, and adverbs. The learning support module 160 may divide the text into the subject and the verb, parenthesize the subject and the verb, and then output the scene dialog screen D3 displayed in light gray.

If the scene dialog screen D3 is printed after the learner selects a learning start button or an output button, the learning support module 160 outputs a scene dialog voice. The learner proceeds with the language learning, such as dictation, shadowing reading, and fill in the blanks, while hearing the scene dialog voice being output from the learning support module 160.

Meanwhile, the learning support module 160 may output the language learning video instead of the scene dialog voice.

In this case, the learning support module outputs the language learning video, and in particular, outputs the language learning video from a time line corresponding to a scene dialog start time of a scene dialog time to a time line corresponding to a scene dialog end time. Further, the learning support module 160 may repeatedly play a section corresponding to the scene dialog time of the language learning video as many times as set.

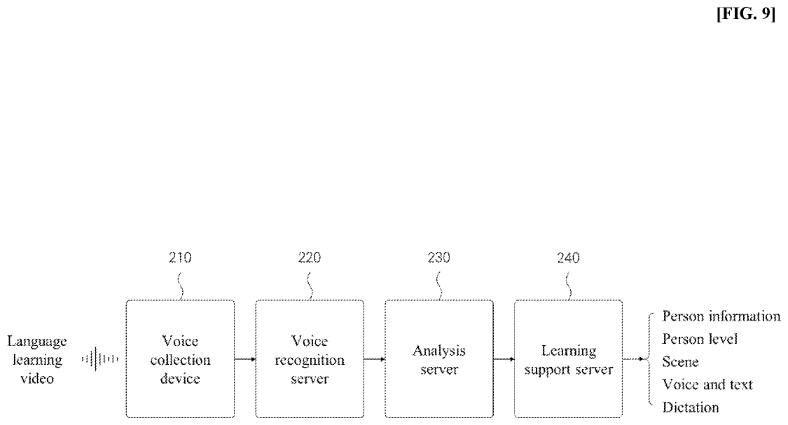

As described above, in order to easily explain the embodiment of the present disclosure, the apparatus 100 for supporting language learning composed of a single device has been exemplified, but the apparatus may be configured to be divided into a plurality of devices and servers. As an example, referring to FIG. 9, the present disclosure may be configured to include a voice collection device 210 including a voice recognition module, a voice recognition server 220 including a speaker classification module 120 and a storage module 140, an analysis server 230 including a text conversion module 130 and a person level configuration module 150, and a learning support server 240 including a learning support module 160.

Hereinafter, a method for supporting language learning using a video according to an embodiment of the present disclosure will be described with reference to the accompanying drawings.

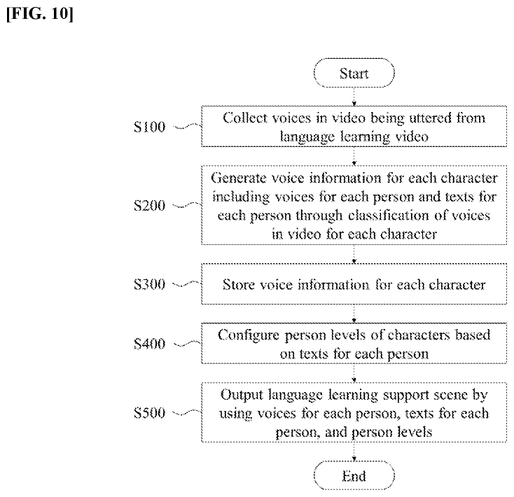

Referring to FIG. 10, the language learning support device 100 collects voices (i.e., voices in a video) that are uttered in a language learning video being viewed by a learner (S100). In this case, the language learning video may be a video that is played by a video player, such as a TV, a smart phone, or a tablet, or a video that is played by the language learning support apparatus 100 according to an embodiment of the present disclosure. It is exemplified that the language learning video is a video of a drama, movie, or animation composed of language voices that are the target of learning.

In the step S100, if a video start message is input, the voice collection module 110 collects voices being uttered from the language learning video. In this case, the voice collection module 110 may recognize first occurrence sound (voice) after the language learning video is played as the video start message. The voice collection module 110 may receive the video start message from a video player that plays the language learning video. In case that the video is played by the language learning support apparatus 100, the voice collection module 110 may recognize a playback request input by the learner as the video start message.

The language learning support apparatus 100 generates voice information for each character including voices for each person through classification of the voices in the video collected in the step S100 for each character appearing in the language learning video and texts for each person through conversion of the voices for each person into texts (S200). Since several characters including the protagonist appear in the language learning video, the speaker classification module 120 generates voice information for each character by classifying the voices in the video of the language learning video for each character.

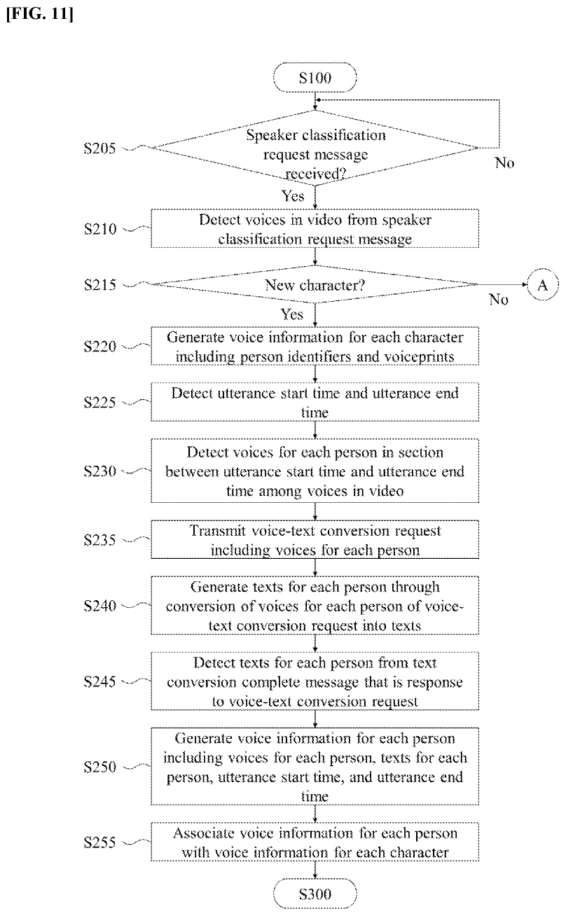

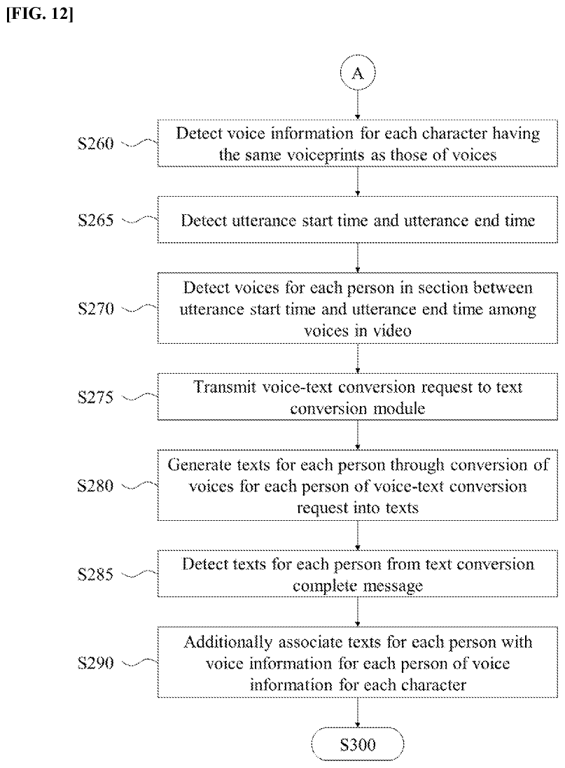

Referring to FIGS. 11 and 12, the voice collection module 110 generates a speaker classification request message including the voices in the video collected in the step S100 in response to a video end message, and transmits the speaker classification request message to the speaker classification module 120. If the speaker classification request message of the voice collection module 110 is received (Yes in S205), the speaker classification module 120 detects the voices in the video from the speaker classification request message (S210).

The speaker classification module 120 determines the character by comparing the voice information for each character including a person identifier and a voiceprint with the voices in the video. In this case, if there is the voice information for each character having the same voiceprint as the voiceprint of the voice in the video, the speaker classification module 120 determines it as the existing character. If there is not the voice information for each character having the same voiceprint as the voiceprint of the voice in the video, the speaker classification module 120 determines it as a new character. If it is determined as the new character (Yes in S215), the speaker classification module 120 generates the voice information for each character including the person identifier and the voiceprint (S220). If the character is determined as the new character, the speaker classification module 120 configures the person identifier, and generates the voiceprint by quantifying the voice characteristics of the corresponding person. The speaker classification module 120 generates the voice information for each character including the person identifier and the voiceprint. In this case, the speaker classification module 120 detects a person name that is the name of the character from the voices of the characters, and may generate the voice information for each character further including the person name.

The speaker classification module 120 detects an utterance start time and an utterance end time of the voice having the same voice characteristics as the characteristics of the voiceprint of the voice information for each character (S225). Here, the utterance start time means the time when the voice utterance of the corresponding person starts in the language learning video, and the utterance end time means the time when the voice utterance of the corresponding person is ended.

The speaker classification module 120 detects, from the voices in the video, the voice between the utterance start time and the utterance end time as the voice for each person (S230).

In the step S230, the speaker classification module 120 may divide the voice information for each person for each scene. That is, after a predetermined period (time) is set after a dialog between characters takes place in one scene, a dialog takes place in a next scene. Based on this, the speaker classification module 120 divides the voice information for each person for each scene.

If a difference between an utterance end time of voice information for each first person of a first character and an utterance start time of voice information for each second person is equal to or shorter than a predetermined time, the speaker classification module 120 configures the voice information for each of the two persons as one scene. In this case, if an utterance start time of voice information for each person of a second character exists between the voice information for each person of the first character, the speaker classification module 120 classifies the voice information for each person of the second character as the same scene as the scene of the voice information for each person of the first character.

If the difference between the utterance end time of the voice information for each first person and the utterance start time of the voice information for each second person exceeds the predetermined time, the speaker classification module 120 configures the voice information for the first person and the voice for the second person as different scenes.

The speaker classification module 120 generates a voice-text conversion request message including the voices for each detected person, and transmits the voice-text conversion request message to the text conversion module 130 (S235).

The text conversion module 130 generates the texts for each person by converting the voices for each person into texts in response to the voice-text conversion request message of the speaker classification module 120 (S240). The text conversion module 130 generates the texts for each person by converting the voices for each person into text values through voice recognition (speech to text (STT)) of the voices for each person detected from the voice-text conversion request message. The text conversion module 130 generates a text conversion complete message including the texts for each person, and transmits the text conversion complete message to the speaker classification module 120.

The texts for each person are detected from the text conversion complete message received in response to the voice-text conversion request message (S245).

The speaker classification module 120 generates the voice information for each person including the voices for each person, the texts for each person, the utterance start time, and the utterance end time (S250).

The speaker classification module 120 associates the voice information for each person with the voice information for each character including person identifiers, person names, and voiceprints (S255).

Meanwhile, if the character is determined as the existing character in the step S215, the speaker classification module 120 detects the voice information for each character having the same voiceprint as the voiceprint of the voice (S260).

The speaker classification module 120 detects the utterance start time and the utterance end time of the voice having the same voice characteristics as the voice characteristics of the voiceprint of the voice information for each character (S265).

The speaker classification module 120 detects the voice between the utterance start time and the utterance end time among the voices in the video as the voice for each person (S270).

The speaker classification module 120 generates the voice-text conversion request message including the detected voices for each person, and transmits the voice-text conversion request message to the text conversion module 130 (S275).

The text conversion module 130 generates the texts for each person by converting the voices for each person into the texts in response to the voice-text conversion request message of the speaker classification module 120 (S280). The text conversion module 130 generates the text conversion complete message including the texts for each person, and transmits the text conversion complete message to the speaker classification module 120.

The speaker classification module 120 detects the texts for each person from the text conversion complete message that is a response to the voice-text conversion request message (S285).

The speaker classification module 120 additionally associates the texts for each person with the voice information for each person of the voice information for each character detected in the step S255 (S280).

The language learning support apparatus 100 stores the voice information for each character generated in the step S200 (S300).

In the step S300, if the speaker classification for the voices in the video is completed, the speaker classification module 120 generates a voice information storage request message for each character including person identifiers, person names, voiceprints, and voice information for each person, and transmits the voice information storage request message to the storage module 140.

In the step S300, if the scene classification is completed, the speaker classification module 120 may generate the voice information storage request message for each character including the person identifiers, the person names, the voiceprints, and the voice information for each person, and may transmit the voice information storage request message to the storage module 140.

The storage module 140 stores the voice information for each character in response to the voice information storage request message for each character of the speaker classification module 120.

The language learning support apparatus 100 configures person levels for the characters of the language learning video by analyzing the voice information for each character generated in the step S300 (S400). The language learning support apparatus 100 configures the person levels of the characters by using the level of the vocabulary being used by the characters appearing in the language learning video.

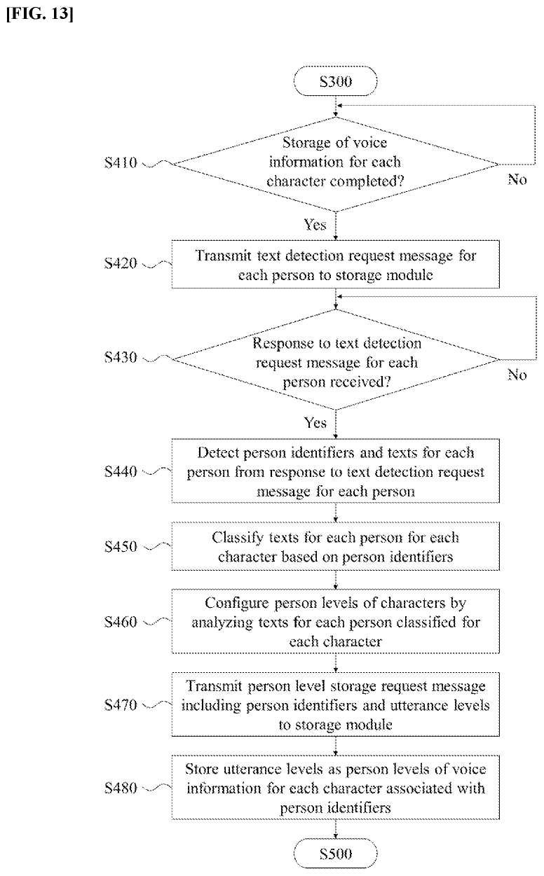

Referring to FIG. 13, after completion of the storage of the voice information for each character, the storage module 140 generates and transmits a storage complete message to the person level configuration module 150.

If the storage of the voice information for each character is completed (Yes in S410), the person level configuration module 150 generates and transmits a text detection request message for each person to the storage module 140 (S420).

The storage module 140 detects the person identifiers and the texts for each person in response to the text detection request message for each person of the person level configuration module 150, and generates and transmits a response including the person identifiers and the texts for each person to the person level configuration module 150.

If a response to the text detection request message for each person is received (Yes in S430), the person level configuration module 150 detects the person identifiers and the texts for each person from the response to the text detection request message for each person (S440).

The person level configuration module 150 classifies the texts for each person for each character based on the person identifiers (S450).

The person level configuration module 150 configures the person levels of the characters by analyzing the texts for each person classified for each character (S460). That is, the person level configuration module 150 determines the level (hereinafter, word level) of a word used by the character in the video and the level (hereinafter, sentence level) of a sentence used by the character in the video through morphological analysis of the texts for each person classified for each character. The person level configuration module 150 configures the utterance level (i.e., person level) of the character by using the word level and the sentence level of the character.

The person level configuration module 150 generates and transmits the person level storage request message including the person identifier and the utterance level to the storage module 140 (S470).

The storage module 140 detects the person identifiers and utterance levels from the person level storage request message in response to the person level storage request message of the person level configuration module 150, and stores the detected utterance levels as the person levels of the voice information for each character in association with the detected person identifiers (S480).

The learning support module 160 outputs various types of language learning support screens for supporting the language learning of the learner by using the voice information for each character generated in the step S300 and the person levels configured in the step S400 (S500).

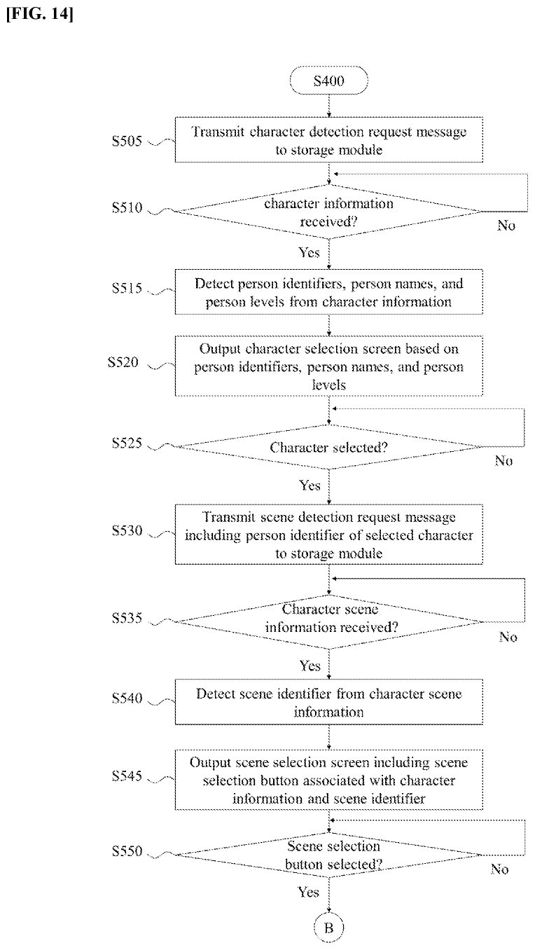

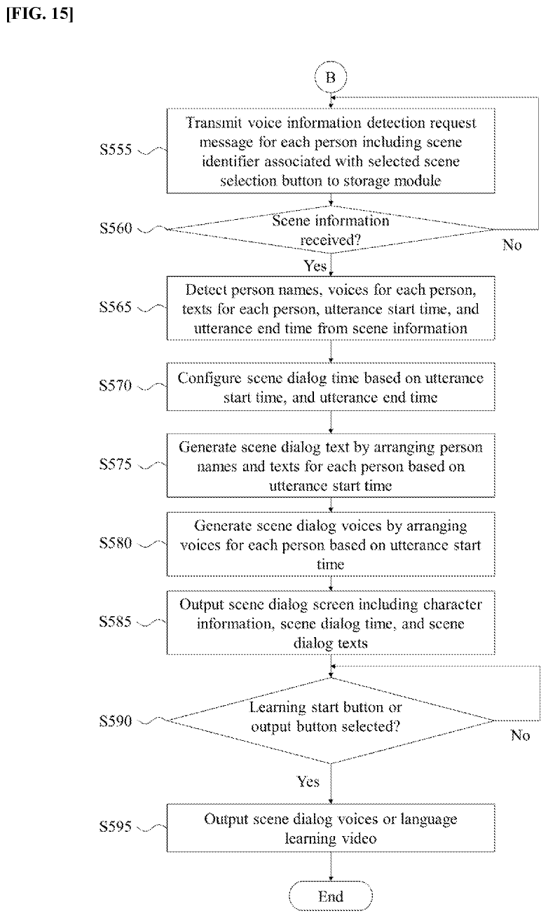

Referring to FIGS. 14 and 15, the learning support module 160 generates and transmits the character detection request message to the storage module 140 (S505).

The storage module detects scenes on which the characters selected by the learner appear in response to the scene detection request message of the learning support module 160. The storage module 140 detects the scene identifiers in association with the person identifiers detected from the scene detection request message. The storage module 140 transmits the character scene information including the detected scene identifiers in response to the scene detection request message. If the character information that is the response of the storage module 140 with respect to the character detection request message is received (Yes in S510), the learning support module 160 detects the person identifiers, the person names, and the person levels from the character information (S515).

The learning support module 160 outputs a character selection screen D1 on which characters of the language learning video are displayed (S520). In this case, the learning support module 160 displays character selection buttons B1 on which icons, person names, and person levels of the characters are displayed, and outputs a character selection screen D1 on which person identifiers match the character selection buttons B1.

If the learner views the person levels on the character selection screen D1, and selects the character by selecting the character selection button B1 to fit the learner's level (Yes in S525), the learning support module 160 detects the person identifier in association with the character selection button B1 selected by the learner, and generates and transmits a scene detection request message including the detected person identifier to the storage module 140 (S530).

The storage module 140 detects the scenes on which the characters selected by the learner appear in response to the scene detection request message. The storage module 140 detects the scene identifiers in association with the person identifiers detected from the scene detection request message. The storage module 140 transmits the character scene information including the detected scene identifiers as a response to the scene detection request message. If the character scene information is received as the response of the storage module 140 with respect to the scene detection request message (Yes in S535), the learning support module 160 detects the scene identifiers from the character scene information (S540).

The learning support module 160 outputs the scene selection screen D2 on which character information including icons, person names, and person levels of the characters are displayed and one or more scene selection buttons B2 are displayed (S545). In this case, the learning support module 160 outputs the scene selection screen D2 on which the scene identifiers match the scene selection buttons B2.

If the scene selection button B2 displayed on the scene selection screen D2 is selected by the learner (Yes in S550), the learning support module 160 generates voice information detection request message for each person including the scene identifiers in association with the scene selection button B2 selected by the learner, and transmits the voice information detection request message to the storage module 140 (S555).

The storage module 140 detects voice information for each person and person names of the scene selected by the learner in response to the voice information detection request message for each person of the learning support module 160. The storage module 140 detects the voice information for each person and person names in association with the scene identifiers detected from the scene detection request message. The storage module 140 transmits the scene information including the detected person names and voice information for each person as a response to the scene detection request message. If the scene information is received as the response of the storage module 140 with respect to the voice information detection request message for each person (Yes in S560), the learning support module 160 detects the person names and the voice information for each person from the scene information, and detects the voices for each person, the texts for each person, the utterance start time, and the utterance end time from the detected voice information for each person (S565).

The learning support module 160 configures a scene dialog time based on the detected utterance start time and utterance end time (S570). The learning support module 160 configures the earliest time among the detected utterance start times as a scene dialog start time, and configures the latest time among the utterance end times as a scene dialog end time. The learning support module 160 generates a scene dialog time including the scene dialog start time and the scene dialog end time.

The learning support module 160 generates scene dialog texts by arranging the person names and the texts for each person based on the detected utterance start time (S575). In this case, the learning support module 160 generates the scene dialog texts for arranging the person names and the texts for each person so that they are located in front (at the top) as the utterance start time thereof is earlier. In other words, the learning support module 160 arranges the person names and the texts for each person based on the detected utterance start time. In this case, the learning support module 160 generates the scene dialog texts on which the person names and the texts for each person are arranged so that they are located in front (at the top) as the utterance start time thereof is earlier.

The learning support module 160 generates scene dialog voices by arranging the voices for each person based on the detected utterance start time (S580). In this case, the learning support module 160 generates the scene dialog voices on which the voices for each person are arranged so that they are located in front (at the top) as the utterance start time thereof is earlier.

The learning support module 160 outputs a scene dialog screen D3 including the character information including the icons, person names, and person levels of the characters, a scene dialog time, and scene dialog texts (S585). In this case, the learning support module 160 may output the scene dialog screen D3 further including a learning start button and/or an output button.

In the step S585, in order for the learner to be able to proceed with the dictation learning by outputting the scene dialog screen D3, the learning support module 160 may output the scene dialog screen D3 on which all texts included in the scene dialog texts are exposed to be displayed in light gray.

In the step S585, the learning support module 160 may parenthesize a specific text, and may output the scene dialog screen D3 displayed in light gray. In this case, the learning support module 160 may select the text being parenthesized based on the learner's vocabulary level or learning history. The learning support module 160 may output the scene dialog screen D3 displayed in light gray after parenthesizing the text corresponding to the parts of speech selected by the learner among nouns, adjectives, verbs, and adverbs. The learning support module 160 may divide the text into the subject and the verb, parenthesize the subject and the verb, and then output the scene dialog screen D3 displayed in light gray.

If the scene dialog screen D3 is printed after the learner selects a learning start button or an output button (Yes in S590), the learning support module 160 outputs a scene dialog voice (S595). The learner proceeds with the language learning, such as dictation, shadowing reading, and fill in the blanks, while hearing the scene dialog voice being output from the learning support module 160.

Meanwhile, the learning support module 160 may output the language learning video instead of the scene dialog voice. In this case, the learning support module outputs the language learning video, and in particular, outputs the language learning video from a time line corresponding to a scene dialog start time of a scene dialog time to a time line corresponding to a scene dialog end time. Further, the learning support module 160 may repeatedly play a section corresponding to the scene dialog time of the language learning video as many times as set.

The above explanation of the present disclosure is merely for exemplary explanation of the technical idea of the present disclosure, and it can be understood by those of ordinary skill in the art to which the present disclosure pertains that various corrections and modifications thereof will be possible in a range that does not deviate from the essential characteristics of the present disclosure. Accordingly, it should be understood that the embodiments disclosed in the present disclosure are not to limit the technical idea of the present disclosure, but to explain the same, and thus the scope of the technical idea of the present disclosure is not limited by such embodiments. The scope of the present disclosure should be interpreted by the appended claims to be described later, and all technical ideas in the equivalent range should be interpreted as being included in the scope of the present disclosure.

### DESCRIPTION OF REFERENCE NUMERALS

100: apparatus for supporting language learning
110: voice collection module
120: speaker classification module
130: text conversion module
140: storage module
150: person level configuration module
160: learning support module

1. An apparatus for supporting language learning comprising:
a voice collection module configured to: collect voices that are uttered in a language learning video being viewed by a learner, and output a speaker classification request message including the voices in the video in response to a video end message that is generated when a playback of the language learning video is ended;
a speaker classification module configured to: generate voices for each person through classification of the voices in the video for each character collected by the voice collection module in response to the speaker classification request message of the voice collection module, output a text conversion request message including the voices for each person, detect texts for each person detected from a text conversion complete message that is a response to the text conversion request message, generate voice information for each character including the voices for each person and the texts for each person, and output a storage request message including the voice information for each character;
a text conversion module configured to: generate the texts for each person through conversion of the voices for each person detected from the text conversion request into the texts in response to the text conversion request of the speaker classification module, and output the text conversion complete message including the texts for each person;
a storage module configured to: store the voice information for each character in response to a storage request message of the speaker classification module, output a response including person identifiers and the texts for each person in response to a text detection request message for each person, detect the person identifiers and the texts for each person in response to a person level storage request message, output a response including the person identifiers and utterance levels, and store person levels in association with the voice information for each character in response to the person level storage request message;
a person level configuration module configured to: transmit the text detection request message for each person to the storage module in response to a storage complete message of the storage module, configure the utterance levels of characters by analyzing the person identifiers and the texts for each person detected from the response of the storage module with respect to the text detection request message for each person, and transmit the person level storage request message including the person identifiers and the utterance levels to the storage module; and
a learning support module configured to output one or more learning support screens based on the voice information for each character stored in the storage module in response to a language learning start request.

2. The apparatus of claim 1, wherein the speaker classification module is configured to: detect the voices in the video from the speaker classification request message of the voice collection module, and determine whether a character newly appears based on voiceprints of the voice information for each pre-generated character and the voices in the video, and
wherein the speaker classification module is configured to: determine the appearing character as the existing character if the voice information for each character having the same voiceprint as the voiceprint of the voice in the video exists, and determine the appearing character as a new character if the voice information for each character having the same voiceprint as the voiceprint of the voice in the video does not exist.

3. The apparatus of claim 2, wherein the speaker classification module is configured to: generate a person identifier if the appearing character is determined as the new character, generate a voiceprint based on the voice determined as the new character, and generate the voice information for each character including the person identifier and the voiceprint.

4. The apparatus of claim 2, wherein the speaker classification module is configured to: detect, from the voices in the video, an utterance start time and an utterance end time of the voice having the same voiceprint as the voiceprint of the voice information for each character, and detect, from the voices in the video, the voice between the utterance start time and the utterance end time as the voice for each person.

5. The apparatus of claim 4, wherein the speaker classification module is configured to divide the voice information for each person for each scene based on the utterance start time and the utterance end time,
wherein if a difference between an utterance end time of voice information for each first person of a first character and an utterance start time of voice information for each second person is equal to or shorter than a predetermined time, the speaker classification module is configured to configure the voice information for each of the two persons as one scene, and
wherein if an utterance start time of voice information for each person of a second character exists between the voice information for each person of the first character, the speaker classification module is configured to configure the voice information for each person of the second character as the same scene as the scene of the voice information for each person of the first character.

6. The apparatus of claim 1, wherein the person level configuration module is configured to: output a text detection request for each person, detect the person identifier and the texts for each person from a response of the storage module with respect to the text detection request for each person, divide the texts for each person for each character based on the person identifiers detected in the step of detecting the person identifiers and the texts for each person, configure the utterance levels of the characters by analyzing the texts for each person classified for each character, and output, to the storage module, a person level storage request message including the person identifiers and the utterance levels.

7. The apparatus of claim 1, wherein the learning support module is configured to: output a character detection request message, detect the person identifiers and the person levels from character information if the character information is received in response to the character detection request message, output a character selection screen for displaying the characters of the language learning video so as to display the person levels of the characters and the character selection screen including character selection buttons matching the person identifiers, detect the person identifiers in association with the character selection buttons selected by the learner, output a scene detection request message including the person identifiers, match the scene identifiers detected from character scene information that is a response to the scene detection request message with the scene selection buttons if the character scene information is received, output a scene selection screen including the scene selection buttons, and output a scene dialog screen on which the texts for each person are arranged in association with the scene identifiers in association with the scene selection buttons selected by the learner.

8. The apparatus of claim 7, wherein the learning support module is configured to: generate a scene dialog voice on which the voices for each person are arranged so that the voices are located in front as the utterance start time thereof is earlier, and output the scene dialog voice together with the scene dialog screen.

9. The apparatus of claim 7, wherein the learning support module is configured to: output a voice information detection request message for each person including the scene identifiers in association with the scene selection buttons selected by the learner, detect the voices for each person, the texts for each person, the utterance start time and the utterance end time from scene information as a response to the voice information detection request message for each person if the scene information is received, configure a scene dialog time including a scene dialog start time configured as the detected earliest utterance start time and a scene dialog end time configured as the detected latest utterance end time, and output the scene dialog screen including scene dialog texts on which the texts for each person are arranged based on the utterance start time.

10. The apparatus of claim 9, wherein the language learning video is output together with the scene dialog screen from a time line corresponding to the scene dialog start time of the scene dialog time to a time line corresponding to the scene dialog end time.

11. A method for supporting language learning performed by a language learning support apparatus, the method comprising:
collecting voices that are uttered in a language learning video being viewed by a learner;
generating voice information for each character including voices for each person through classification of the voices in the video for each character collected in the step of collecting the voices in the video and texts for each person through conversion of the voices for each person into the texts;
storing the voice information for each character generated in the step of generating the voice information for each character;
configuring utterance levels of characters by analyzing the voice information for each character stored in the step of storing the voice information for each character, and configuring the utterance levels as person levels of the characters; and
outputting a learning support screen including the person levels configured in the step of configuring as the person levels and the voice information for each character.

12. The method of claim 11, wherein the generating of the voice information for each character comprises:
detecting, by a speaker classification module, the voices in the video from a speaker classification request message of a voice collection module having collected the voices in the video;
determining, by the speaker classification module, whether a character newly appears based on the voice information for each pre-generated character and the voices in the video;
generating, by the speaker classification module, the voice information for each character including person identifiers and voiceprints if the character is determined as a new character in the step of determining the characters;
detecting, by the speaker classification module, an utterance start time and an utterance end time of the voice having the same voiceprint from the voices in the video detected in the detection step;
detecting, by the speaker classification module, the voice between the utterance start time and the utterance end time among the voices in the video as the voice for each person;
outputting, by the speaker classification module, a voice-text conversion request message including the voices for each person, and detecting texts for each person through conversion of the voices for each person into the texts from a text conversion complete message that is a response to the voice-text conversion request message;
generating, by the speaker classification module, voice information for each person including the voices for each person, the texts for each person, the utterance start time, and the utterance end time; and
associating, by the speaker classification module, the voice information for each person generated in the step of generating the voice information for each person with the voice information for each character generated in the step of generating the voice information for each character.

13. The method of claim 11, wherein the generating of the voice information for each character comprises:
detecting, by a speaker classification module, the voices in the video from a speaker classification request message of a voice collection module having collected the voices in the video;
determining, by the speaker classification module, whether a character newly appears based on the voice information for each pre-generated character and the voices in the video;
detecting, by the speaker classification module, the voice information for each character having the same voiceprints as voiceprints of the voices in the video if the character is determined as an existing character in the step of determining the characters;
detecting, by the speaker classification module, an utterance start time and an utterance end time of the voice having the same voiceprint as the voiceprint of the voice information for each character from the voices in the video;
detecting, by the speaker classification module, the voice between the utterance start time and the utterance end time among the voices in the video as the voice for each person;
outputting, by the speaker classification module, a voice-text conversion request message including the voices for each person, and detecting texts for each person through conversion of the voices for each person into the texts from a text conversion complete message that is a response to the voice-text conversion request message;
generating, by the speaker classification module, voice information for each person including the voices for each person, the texts for each person, the utterance start time, and the utterance end time; and
associating, by the speaker classification module, the voice information for each person generated in the step of generating the voice information for each person with the voice information for each character generated in the step of generating the voice information for each character.

14. The method of claim 12, wherein the determining of whether the character newly appears determines the character as the existing character if the voice information for each character having the same voiceprint as the voiceprint of the voice in the video exists, and determines the character as a new character if the voice information for each character having the same voiceprint as the voiceprint of the voice in the video does not exist.

15. The method of claim 12, further comprising dividing, by the speaker classification module, the voice information for each person detected in the step of detecting as the voices for each person based on the utterance start time and the utterance end time for each scene,
wherein the dividing for each scene includes:
if a difference between the utterance end time of the voice information for each first person of a first character and the utterance start time of the voice information for each second person is equal to or shorter than a predetermined time, configuring the voice information for each of the two persons as one scene; and
if the utterance start time of the voice information for each person of a second character exists between the voice information for each person of the first character, configuring the voice information for each person of the second character as the same scene as the scene of the voice information for each person of the first character.

16. The method of claim 11, wherein the configuring of the utterance levels as person levels of the characters comprises:
outputting, by a person level configuration module, a text detection request for each person;
detecting, by the person level configuration module, the person identifiers and the texts for each person from a response to the text detection request for each person;
classifying, by the person level configuration module, the texts for each person for each character based on the person identifiers detected in the step of detecting the person identifiers and the texts for each person;
configuring, by the person level configuration module, the utterance levels of the characters by analyzing the texts for each person classified for each character in the step of classifying for each character; and
outputting, by the person level configuration module, a person level storage request message including the person identifiers and the utterance levels.

17. The method of claim 11, wherein the outputting of the learning support screen comprises:
outputting, by a learning support module, a character detection request message;
detecting, by the learning support module, the person identifiers and person levels from character information if the character information is received in response to the character detection request message;
outputting, by the learning support module, a character selection screen for displaying the characters of the language learning video so as to display the person levels of the characters and the character selection screen including character selection buttons matching the person identifiers;
detecting, by the learning support module, the person identifiers in association with the character selection buttons selected by the learner, and outputting a scene detection request message including the person identifiers;
detecting, by the learning support module, scene identifiers from character scene information that is a response to the scene detection request message if the character scene information is received;
matching, by the learning support module, the scene identifiers detected in the step of detecting the scene identifiers with scene selection buttons, and outputting a scene selection screen including the scene selection buttons; and
outputting, by the learning support module, a scene dialog screen on which the texts for each person are arranged in association with the scene identifiers in association with the scene selection buttons selected by the learner.

18. The method of claim 17, wherein the outputting of the scene dialog screen comprises:
outputting, by the learning support module, a voice information detection request message for each person including the scene identifiers in association with the scene selection buttons selected by the learner, and detecting the voices for each person, the texts for each person, the utterance start time and the utterance end time from scene information as a response to the voice information detection request message for each person if the scene information is received;
configuring, by the learning support module, a scene dialog time including a scene dialog start time configured as the detected earliest utterance start time and a scene dialog end time configured as the detected latest utterance end time;
generating, by the learning support module, the scene dialog texts on which the texts for each person are arranged based on the utterance start time; and
outputting, by the learning support module, the scene dialog screen including the scene dialog texts.

19. The method of claim 18, wherein the outputting of the scene dialog screen further comprises:
generating, by the learning support module, a scene dialog voice on which the voices for each person are arranged so that the voices are located in front as the utterance start time thereof is earlier; and
outputting, by the learning support module, the scene dialog voice together with the step of outputting the scene dialog screen.

20. The method of claim 18, wherein the outputting of the scene dialog screen further comprises:
outputting, by the learning support module, the language learning video from a time line corresponding to the scene dialog start time of the scene dialog time to a time line corresponding to the scene dialog end time together with the step of outputting the scene dialog screen.
